(19) United States
(12) Patent Application Publication
(10) Pub. No.: US 2005/0231663 A1
(43) Pub. Date: Oct. 20, 2005

(54) Reflector and liquid crystal display device using the same

(75) Inventor: Katsumasa Yoshii, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/104,774

(22) Filed: Apr. 13, 2005

(30) Foreign Application Priority Data
Apr. 16, 2004 (JP) 2004-121658

(51) Int. Cl. G02F 1/1335

(52) U.S. Cl. 349/113

(57) ABSTRACT

The reflection characteristic of the reflector is varied in accordance with the distance from the central portion of the display region of the reflection surface, the intensity of the light which is incident to the reflector and reflected on the reflection surface is to be uniform in the range of the ± expected angle θ, and the expected angle θ satisfies the relationship expressed by the following formula (1)
θ(degree)=tan⁻¹(H/2 L) (1) (In the equation, θ is the expected angle, H is the dimension of the vertical direction of the display region and is in the range of 2 cm to 30 cm, and L is the distance from the center of the display region to the observing point and is in the range of 10 cm to 300 cm). A liquid crystal display device has a reflector attached in the inner side or outer side of a liquid crystal cell.

### BACKGROUND OF THE INVENTION

1. Field of the Invention

The present invention relates to a reflector and a liquid crystal display device using the same.

2. Description of the Related Art

Generally, in the display type of a liquid crystal display device, there are a transflective liquid crystal display device having a back light unit, a transmissive liquid crystal display device, and a reflective liquid crystal display device. The reflective liquid crystal display device is the liquid crystal display device for performing the display using only external light such as solar light or illumination light without the back light unit, and is mainly used in, for example, a thin personal digital assistant necessary to have low power consumption and light weight. Also, the transflective liquid crystal display device operates in a transmissive mode by turning on a back light unit when external light can not be sufficiently obtained and operates in a reflective mode without turning on the back light unit when external light can be sufficiently obtained, and is mainly used in a portable electronic equipment such as a portable telephone or a note-type personal computer (note-type PC).

The display performance of the transflective or the reflective liquid crystal display device is necessary to be bright in the reflective mode.

FIG. 21 is a cross-sectional side view illustrating an example of a conventional reflective liquid crystal display device provided with a reflecting plate in the liquid crystal display panel (For example, see Japanese Patent No. 3019058).

The reflective liquid crystal display device includes an opposite transmissive substrate 101, a liquid crystal layer 110, and an element substrate 102 having light reflectivity in this order when being viewed from the incident direction of the light. The element substrate 102 is provided with a reflective scattering band for reflecting and scattering the light Q transmitting the opposite substrate 101. The scattering band is made of a reflecting plate 130 which is composed of a high-reflectivity metal film 122 having irregularities 122a on the surface thereof and an insulating layer 128 disposed under the metal film. The display region of the reflecting plate 130 is formed with two regions, that is, a region B having reflection characteristic of high directivity and a region A having reflection characteristic of high diffusivity, for each portion corresponding to each pixel (each pixel corresponding portion). Each region is formed with irregularities having a mutually different average slope angle.

The reflecting plate 130 is manufactured by forming initial irregularities on a glass or silicon oxide film using a sand blast method, etching it with hydrofluoric acid aqueous solution, and forming an A1 film thereon. As shown in FIG. 22, the connecting portion (boundary portion) 122e between the convex portion 122c and the convex portion 122c of the high-reflectivity metal film 122 has a curved surface, and the connecting portion (boundary portion) 122d between the concave portion 122b and the concave portion 122b also has a curved surface. Accordingly, the slope of the sectional curve of the longitudinal section of the high-reflectivity metal film 122 is continuous, in other words, a first-order derivative of the sectional curve of the longitudinal section is continuous.

In the liquid crystal display device including the conventional reflecting plate, since each pixel corresponding portion of the display region of the reflecting plate 130 is formed with the region B and the region C having the same shape, the each pixel corresponding portion has the same reflection characteristic (the characteristic shown by the curve (C) in FIG. 23) obtained by combining the reflection characteristic from the region A (the characteristic shown by the curve (B) of FIG. 23) and the reflection characteristic from the region B (the characteristic shown by the curve (A) of FIG. 23). Therefore, the reflection characteristic in the display region becomes substantially equal. Also, the reflection characteristic (A) and (B) show the Gaussian distribution type reflection characteristic with respect to the regular reflection angle of the incident light, respectively, and the reflection characteristic (C) also show the Gaussian distribution type reflection characteristic with respect to the regular reflection direction of the incident light, thereby the reflection characteristic in the display region also show the Gaussian distribution type reflection characteristic.

In case that the liquid crystal display device is assembled in the display portion of an electronic equipment such as the personal digital assistant, for example, the note-type personal computer, as shown in FIG. 24, generally, the liquid crystal display device is often viewed in the direction closed to the normal direction h for the display surface. FIG. 24 illustrates the state using the portable electronic equipment in which the display portion 200 composed of the liquid crystal display device shown in FIG. 21 is included in the body 205.

However, in the conventional liquid crystal display device having the Gaussian distribution type reflection characteristic as above-mentioned, if the size of the display region is increased, there are problems that the difference of reflectivity in the reflecting plate becomes large and the luminance unevenness is generated.

For example, a) in case that the liquid crystal display device has the longitudinal dimension H1 (the dimension of vertical direction) of the extent of 5 cm in the display region, if the distance L1 between the observing point ob of the observer and the center of the display region is 30 cm, the expected angle θ is the extent of 4.8 degree. b) In case that the liquid crystal display device has the longitudinal dimension H1 of the extent of 15 cm (equivalent of 10 inch in diagonal line) in the display region, if the distance L1 between the observing point ob of the observer and the center of the display region is 30 cm, the expected angle θ is the extent of 14 degree, which is three times as large as the case of a).

Further, in case of b), in the reflection angle when the parallel light of 30 degree is incident to the reflecting plate, the reflection angle of the light a incident to the upper portion of the display region of the reflecting plate is 14°, the reflection angle of the light b incident to the central portion is 0°, and the reflection angle of the light c incident to the lower portion is −14°. Accordingly, there are problems that the difference of the reflectivity is generated in accordance with the reflecting location in the reflecting plate (the reflectivity in accordance with the light receiving angle is considerably different, as shown in FIG. 25) and the luminance unevenness is generated.

### SUMMARY OF THE INVENTION

The present invention has been made to solve the above-mentioned problems, and it is an advantage of the present invention to provide a reflector, which can obtain the uniform and sufficiently high luminance although the area of the display surface is increased.

Moreover, it is another advantage of the present invention to provide a liquid crystal display device which can the uniform brightness and can improve the visibility although the area of the display region is increased.

In order to obtain the above-mentioned advantage, the present invention employs the follow structure.

The reflector of an aspect of the present invention is the reflector having a reflection surface provided in a liquid crystal display device, and the reflection characteristic of the reflector is varied in accordance with the distance from the central portion of the display region in the reflection surface, the intensity of the light which is incident to the reflector and reflected on the reflection surface is to be uniform in the range of a ± expected angle, and the expected angle satisfies the relationship expressed by the following formula (1)
θ(degree)=tan⁻¹(H/2 L) (1)

(In the formula, θ is the expected angle, H is the dimension of the vertical direction of the display region and is in the range of 2 cm to 30 cm, and L is the distance from the center of the display region to the observing point and is in the range of 10 cm to 300 cm).

Also, in the reflector of an aspect of the present invention, the display region of the reflection surface is the range corresponding to the display region of the liquid crystal display device having the reflector.

Furthermore, the reflector according to an aspect of the present invention may have a reflection characteristic that a rising angle at the upper portion located above the central portion in the display region is shifted to a high angle side in comparison with one at the central portion, and a rising angle at the lower portion located below the central portion in the display region is shifted to a low angle side in comparison with one at the central portion. Also, the center of the display region is the reference location and any locations x in the reflection surface is represented by the distance from the center of the display region, in case that the upper side above the center in the display region is defined as (+) and the lower side below the center in the display region is defined as (−), the reflection characteristic at any locations x in the reflection surface may have the reflection characteristic that is shifted by θ (degree)=tan⁻(x/L) on the basis of the reflection characteristic at the reference location (In the formula, L is the distance from the center of the display region to the observing point and θ is the expected angle).

In the present invention, the rising angle of the reflection characteristic means a minimum light receiving angle when the reflection characteristic of the low angle side is increased, in the graph showing the relationship between the intensity (the reflectivity) of the light which is incident to the reflector and reflected on the reflection surface and the light receiving angle.

Moreover, the reflector has a plurality of reflective concave portions irregularly formed on a metal film formed on a base material or the surface of the base material, the inner side of the concave portion has a curved surface which is a portion of a spherical surface or a aspheric surface, and the slope of the sectional curve of the longitudinal section between the adjacent concave portions or the boundaries of the concave portions is discontinuous so that the metal film or the surface of the base material is to be the reflective surface. In this case, at least one of the depth, the width, the curvature radius of the curved surface, and the slope angle of the curved surface of the plurality of the concave portions is varied in accordance with the distance from the central portion of the display region in the reflection surface.

In addition, the reflector has a plurality of reflective concave portions irregularly formed on a metal film formed on a base material or the surface of the base material, the inner side of the convex portion has a curved surface which is a portion of a spherical surface or an aspheric surface, and the slope of the sectional curve of the longitudinal section between the adjacent convex portions or the boundaries of the convex portions is discontinuous so that the metal film or the surface of the base material is to be the reflective surface, wherein at least one of the depth, the width, the curvature radius of the curved surface and the slope angle of the curved surface of the plurality of the convex portions is varied in accordance with the distance from the central portion of the display region in the reflection surface.

In the present invention, the slope angle of the curved surface of the concave portion or the convex portion means the absolute value of the angle between the base material surface and the contact surface at any locations on the curved surface or the angle for the horizontal plane (metal reflecting film surface) of the slope in the minute range, when taking a minute range having, for example, a width of 0.5 μm at any locations of the outer side of the convex portion or the inner side of the concave portion.

In addition, a liquid crystal display device, wherein an electrode and a orientation film are formed at the inner side of one substrate which is the observing side among a pair of substrates which faces to each other through a liquid crystal layer and the liquid crystal formed with an electrode and an orientation film are provided at the inner side of the other substrate far from the observing side, the reflector according to the above aspect of the invention is formed between the other substrate and the polarization film formed at the inner side thereof or on the outer side of the other substrate.

### BRIEF DESCRIPTION OF THE DRAWINGS

FIG. 1 is a partial cross-sectional view illustrating a reflective liquid crystal display device according to a first embodiment of the present invention;

FIG. 2 is a perspective view illustrating the reflector in the erected state of the liquid crystal display device shown in FIG. 1;

FIG. 3 is a plan view illustrating the reflection characteristic of the reflector included in the liquid crystal display device shown in FIG. 1;

FIG. 4 is a perspective view illustrating the reflector in the erected state of the liquid crystal display device shown in FIG. 1, the distance from the reference location of each line, and the expected angle;

FIG. 5 is a view illustrating the reflection characteristic of the light incident by −30 degree with respect to the locations of (i) to (iv) line in the display region of the reflector shown in FIG. 4;

FIG. 6 is a view illustrating the reflection characteristic of the light incident by −30 degree with respect to the locations of (iv) to (vii) line in the display region of the reflector shown in FIG. 4;

FIG. 7 is a perspective view illustrating a portion of the reflector included in the liquid crystal display device shown in FIG. 1;

FIG. 8 is a perspective view illustrating a first example of the concave portion formed on the metal reflecting film of the reflector shown in FIG. 7;

FIG. 9 is a cross-sectional view of the Y-axis direction of the concave portion shown in FIG. 8;

FIG. 10 is a perspective view illustrating a second example of the concave portion formed on the metal reflecting film of the reflector shown in FIG. 7;

FIG. 11 is a cross-sectional view of the X-axis direction of the concave portion shown in FIG. 10;

FIG. 12 is a cross-sectional view of the Y-axis direction of the concave portion shown in FIG. 10;

FIG. 13 is a cross-sectional view illustrating a third example of the concave portion formed on the metal reflecting film of the reflector shown in FIG. 7;

FIG. 14 is a cross-sectional view illustrating a fourth example of the concave portion formed on the metal reflecting film of the reflector shown in FIG. 7;

FIG. 15 is a view illustrating the sectional shape of the reflector shown in FIG. 7;

FIG. 16 is a side view of the reflector provided according to an embodiment in the erected state thereof;

FIG. 17 is view illustrating the relationship between the rising angle and the distance from the reference location of the display region in the reflector according to the embodiment;

FIG. 18 is a cross-sectional view illustrating the concave portion formed at the vicinity of the (c) point on the display region of the reflector according to the embodiment;

FIG. 19 is a view illustrating the reflection characteristic of the reflector according to the embodiment;

FIG. 20 is a view illustrating the reflection characteristic of the reflector according to the comparative example;

FIG. 21 is a cross-sectional side view illustrating an example of a conventional reflective liquid crystal display device;

FIG. 22 is a cross-sectional view illustrating the reflecting layer of a reflecting plate included in the reflective liquid crystal display device shown in FIG. 21;

FIG. 23 is a view illustrating the reflection characteristic of the reflecting plate included in the reflective liquid crystal display device shown in FIG. 21;

FIG. 24 is a view illustrating the usage state of portable electronic equipment including the conventional liquid crystal display device;

FIG. 25 is a view illustrating the reflectivity of each portion in the surface of the conventional reflecting plate; and

FIG. 26 is a longitudinal cross-sectional view schematically illustrating the shape of the concave portion formed at the vicinity of (a), (b), (c), (d), and (e) points in the reflector according to the embodiment.

### DESCRIPTION OF THE PREFERRED EMBODIMENT

Hereinafter, the embodiments of an aspect of the present invention will be described with reference to the accompanying drawings. In the following drawings, the film thickness or the size ratio of each component is adjusted in order to be recognizable in the drawings.

### First Embodiment

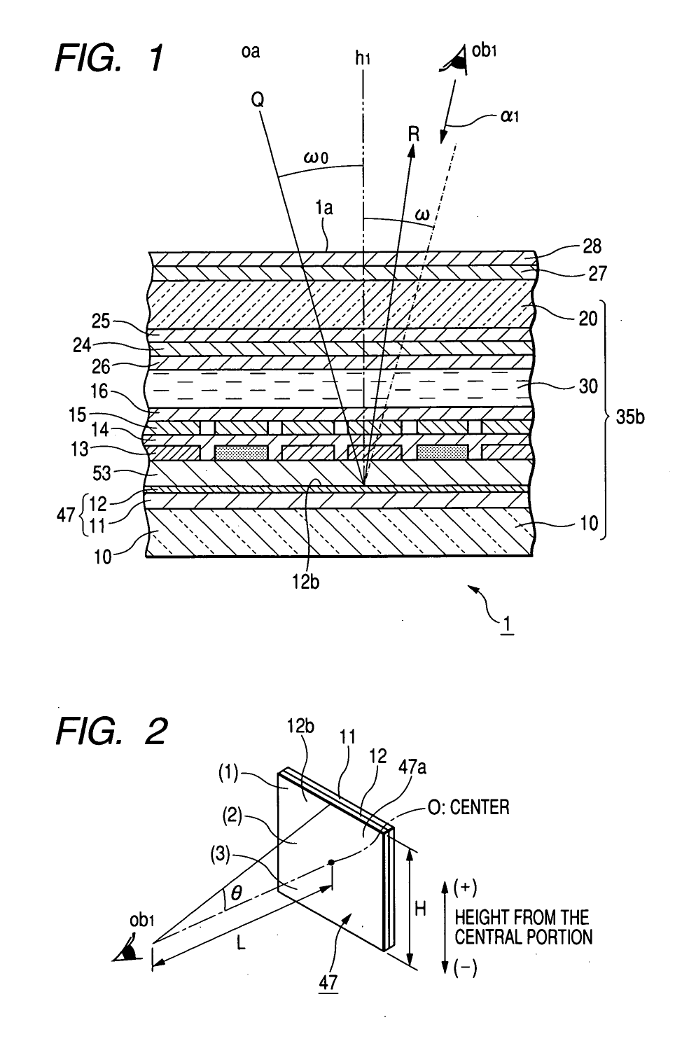

FIG. 1 is a view schematically illustrating a partial cross-sectional structure of a simple matrix type reflective liquid crystal display device according to a first embodiment of the present invention.

In FIG. 1, the reflective liquid crystal display device 1 includes a first substrate 10 (one substrate far from a observer) and a second substrate 20 (the other substrate at the side of the observer) made of a transparent glass opposed each other and provided with a liquid crystal layer 30 therebetween. The first substrate 10 and the second substrate 20 are attached by the seal material (not shown) annularly provided at the periphery thereof.

On the inner side (the side of the liquid crystal layer 30) of the first substrate 10, a reflector 47 according to an embodiment of the present invention, a transparent interposing layer 53 formed by request, a color filter 13 for displaying the color, an overcoat film 14 (transparent planarization layer) for planarizing the irregularities formed by the color filter 13, a transparent electrode layer (electrode) 15 for operating the liquid crystal layer 30, and a orientation film 16 for controlling the orientation of the liquid crystal molecules constituting the liquid crystal layer 30 are laminated in this order. In addition, on the inner side (the side of the liquid crystal layer 30) of the second substrate 20, a transparent electrode layer (electrode) 25, an overcoat film 24, and an orientation film 26 are laminated in this order.

Also, the transparent electrode layer 15 and the transparent electrode layer 25 having the liquid crystal layer 30 interposed therebetween are formed in mutually crossing-stripe shape and construct a simple matrix type reflective liquid crystal display device having pixels which are intersection area thereof.

A liquid crystal cell 35b is composed of the first substrate 10, the second substrate 20, and the components provided between the substrates.

On the opposite side of the liquid crystal layer 30 with respect to the second substrate 20 (the outer side of the second substrate 20), a retardation film 27 and a polarization plate 28 are laminated in this order.

The liquid crystal display device 1 is assembled in the display portion of the electronic equipment such as the personal digital assistant, for example, note-type PC. However, when using the electronic equipment, the display portion composed of the liquid crystal display device 1 is often viewed in the inclined state or in the erected state. The display region of the liquid crystal display device 1 is the substantially overall surface of the liquid crystal cell surface. However, there are non-display regions not contributing to the display at the periphery of the display region in the actual liquid crystal display device.

The reflector 47 provided in the liquid crystal cell 35b is, for example, composed of an organic film 11, a metal reflecting film (metal film) 12 formed on the organic film 11. The organic film 11 provides irregularities on the metal reflecting film 12 formed thereon to efficiently scatter the reflected light. The surface 12b of the metal reflecting film 12 is the reflection surface.

FIG. 2 is a perspective view illustrating the reflector when using the liquid crystal display device in the erected state. In FIG. 2, reference numeral 47a indicates the display region of the reflection surface and is the region corresponding to the display region of the liquid crystal display device 1. Also, in FIG. 2, reference numeral 2 indicates the central portion of the display region 47a of the reflector surface and the central portion 2 is the horizontal band-shaped portion including the center O of the display region 47a. The reference numeral 1 indicates the upper portion of the display region 47a and is the horizontal band-shaped portion located at the upper side above the central portion 2 (this is to be the inside when the device 1 is laid in the inclined state or the horizontal state). The reference numeral 3 indicates the lower portion of the display region 47a and is the horizontal band-shaped portion located at the lower side below the central portion 2 (this is the front side when the device 1 is laid in the inclined state or the horizontal state).

The reflection characteristic of the reflector 47 is varied in accordance with the distance from the central portion 2 of the display region 47a in the reflection surface 12b and the intensity of the light which is incident to the reflector 47 and then is reflected on the reflection surface 12b is to be uniform in the range of the a ± expected angle.

In addition, the expected angle satisfies the relationship expressed by a following formula (1).
θ (degree)=tan⁻¹(H/2 L) (1)

(In the formula, θ is the expected angle, H is the dimension of the vertical direction of the display region 47a and is in the range of 2 cm to 30 cm, and L is the distance from the center O of the display region 47a to the observing point ob1 and is in the range of 10 cm to 300 cm)

For example, in case that H of the display region 47a is 30 cm and L thereof is 40 cm, θ becomes about 20 degree. Accordingly, the intensity of the light, which is incident to the reflector 47 and then is reflected on the reflection surface 12b, is to be uniform in the range of the ±20 degree.

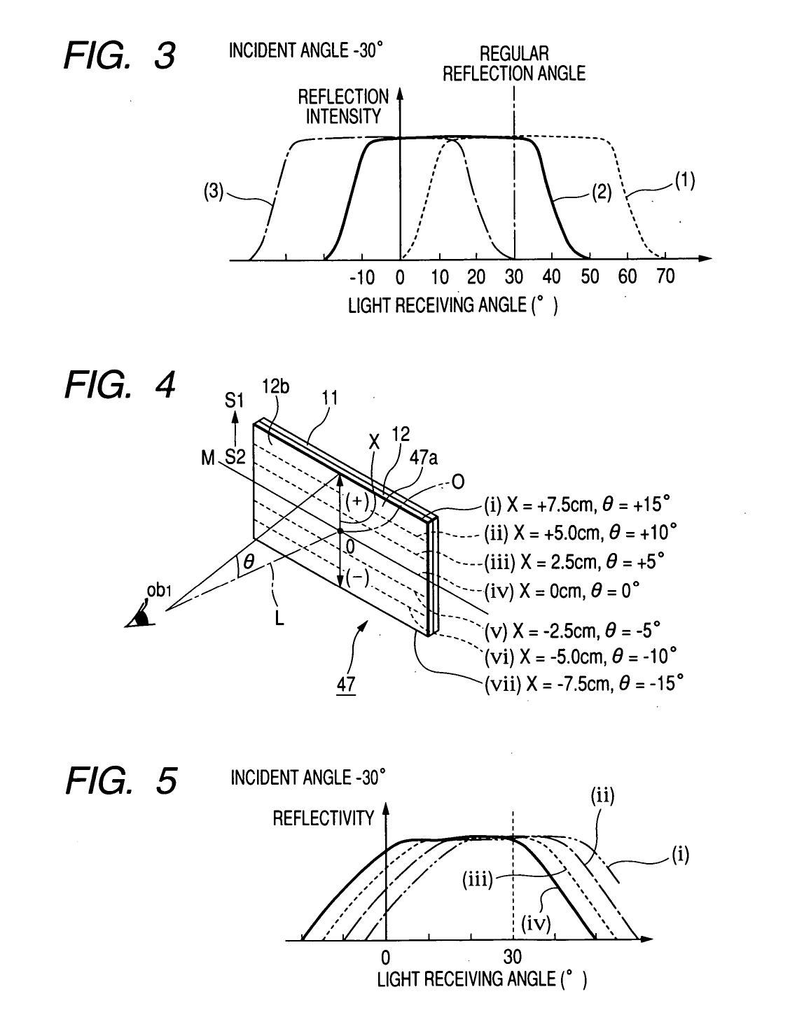

As a means for equalizing the intensity of the reflected light in the range of the ± expected angle, the reflection characteristic of the incident light Q which is incident to the central portion 2 of the display region 47a in the reflection surface 12b by −30 degree represents the characteristic shown by the solid line of FIG. 3. In case that the rising angle is −20 degree, the forming condition of the irregularities formed in the upper portion 1 is controlled so that the rising angle of the reflection characteristic of the incident light Q which is incident to the upper portion 1 by −30 degree is shifted to the high angle side in comparison with the reflection characteristic of the central portion 2. Preferably, the forming condition of the irregularities formed in the upper portion 1 is controlled so that the rising angle is more shifted to the high angle side by +20 degree in comparison with the reflection characteristic of the central portion 2 to represent the characteristic shown by the dotted line in FIG. 3, which the rising angle becomes 0 degree.

Also, the forming condition of the irregularities formed in the lower portion 3 is controlled so that the rising angle of the reflection characteristic of the incident light Q which is incident to the lower portion 3 by −30 degree is shifted to the low angle side in comparison with the reflection characteristic of the central portion 2.

Preferably, the forming condition of the irregularities formed in the lower portion 3 is controlled so that the rising angle is shifted to the low angle side by −20 degree in comparison with the reflection characteristic of the central portion 2 to represent the characteristic shown by the one-dot chain line in FIG. 3, which the rising angle becomes −40 degree.

The distribution width of the reflection characteristic at the upper portion 1 and the lower portion 3 shown in FIG. 3 has the same size as the distribution width of the reflection characteristic at the central portion 2.

Furthermore, in the present embodiment, in the sign of the incident angle or the reflection angle, the angle of the light source side for the normal direction h1 on the reflector surface is defined as minus and the angle of the opposite side opposite to the light source is defined as plus.

Furthermore, as another means for equalizing the intensity of the reflected light in the ± expected angle range, in case that the center O of the display region 47a of the reflector 47 in the erected state as shown in FIG. 4 is set to any locations, any locations x of the reflector surface 47a are represented by the distance from the center O of the display region 47a, the upper location above the horizontal line M passing through the center O of the display region 47a is defined as (+) and the lower location below the horizontal line M is defined as (−), the forming condition of the irregularities formed in the metal reflecting film 12 is controlled so that the reflection characteristic at the location x of the reflector surface has the reflection characteristic shifted by θ (degree)=tan⁻¹(x/L) (In the formula, L is the distance from the center O of the display region 47a to the observing point ob1 and θ is the expected angle) on the basis of the reflection characteristic at the reference location (x=0 cm).

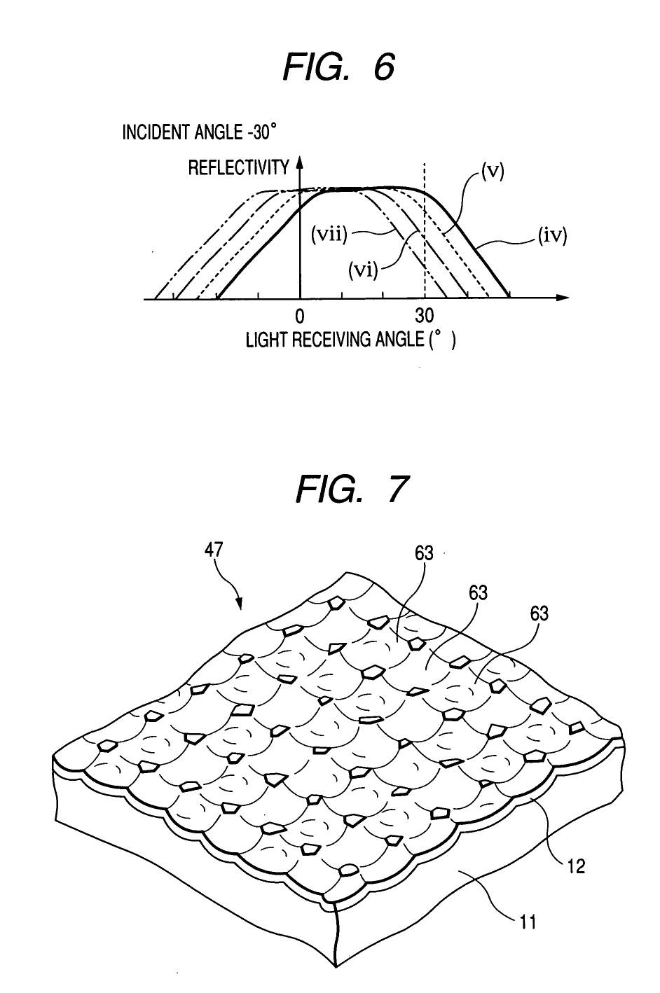

For example, when the dimension of the display region 47a in the reflector 47 shown in FIG. 4 is 10 inch in diagonal line, H is 15 cm and the distance L from the center O to the observing point ob1 is 28 cm, and the location x of the line and the expected angle θ having reference numerals (i) to (vii) in the FIG. 4 are in any of the following case, the reflection characteristic of each location x (each line) is shifted by the expected angle of each location x (each line) on the basis of the reflection characteristic when x=0 cm as shown in FIGS. 5 to 6.
Line (i) x=+7.5 cm, expected angle θ=+15 degree
Line (ii) x=+5.0 cm, expected angle θ=+10 degree
Line (iii) x=+2.5 cm, expected angle θ=+5 degree
Line (iv) x=0 cm, expected angle θ=0 degree
Line (v) x=−2.5 cm, expected angle θ=−5 degree
Line (vi) x=−5.0 cm, expected angle θ=−10 degree
Line (vii) x=−7.5 cm, expected angle θ=−15 degree

FIGS. 5 and 6 show the reflection characteristic of the incident light Q, which is incident to the display region 47a of the reflector 47 shown in FIG. 4 by −30 degree.

Since the reflection characteristic of the incident light Q which is incident to the line (iv) of the display region 47a represents the characteristic shown by the solid line (iv) in FIG. 5, the forming condition of the irregularities formed on the metal reflecting film 12 is controlled so that the reflection characteristic of the line (iii) represents the reflection characteristic shifted to the high angle side by +5 degree from the reflection characteristic shown by the solid line (iv) in FIG. 5, the reflection characteristic of the line (ii) represents the reflection characteristic shifted to the high angle side by +10 degree from the reflection characteristic shown by the solid line (iv) in FIG. 5, and the reflection characteristic of the line (i) represents the reflection characteristic shifted to the high angle side by +15 degree from the reflective characteristic shown by the solid line (iv) in FIG. 5.

In addition, the forming condition of the irregularities formed on the metal reflecting film 12 is controlled so that the reflection characteristic of the line (v) represents the reflection characteristic shifted to the low angle side by −5 degree from the reflection characteristic shown by the solid line (iv) in FIG. 6, the reflection characteristic of the line (vi) represents the reflection characteristic shifted to the low angle side by −10 degree from the reflection characteristic shown by the solid line (iv) in FIG. 6, and the reflection characteristic of the line (vii) represents the reflection characteristic shifted to the low angle side by −15 degree from the reflection characteristic shown by the solid line (iv) in FIG. 6.

It is the most preferable characteristic that the parameter (condition) for forming a concave portion controlled in accordance with the expected angle when observing the panel at the observing side is continuously varied in accordance with the variation of the expected angle. However, actually, the parameter is varied in accordance with the (band-shaped) region in the range which moiré is not viewed.

FIG. 7 is a perspective view illustrating a portion of the reflector 47.

The surface of the metal reflecting film 12 in the reflector 47 is provided with a plurality of reflective concave portions 63 irregularly formed, as shown in FIG. 7.

In the section shape of the metal reflecting film 12 in the reflector 47 according to the present embodiment, the slope of the sectional curve of the longitudinal section at the boundary between the concave portions is discontinuous as shown in FIG. 15. In other words, a first-order derivative of the sectional curve of the vertical section is discontinuous.

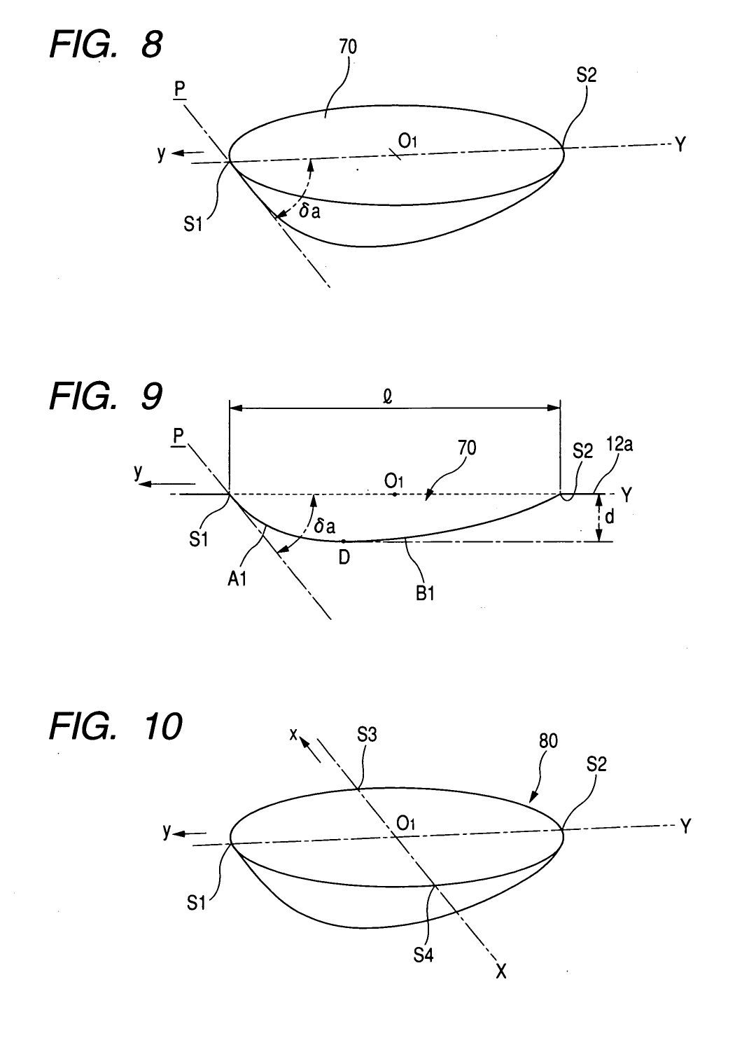

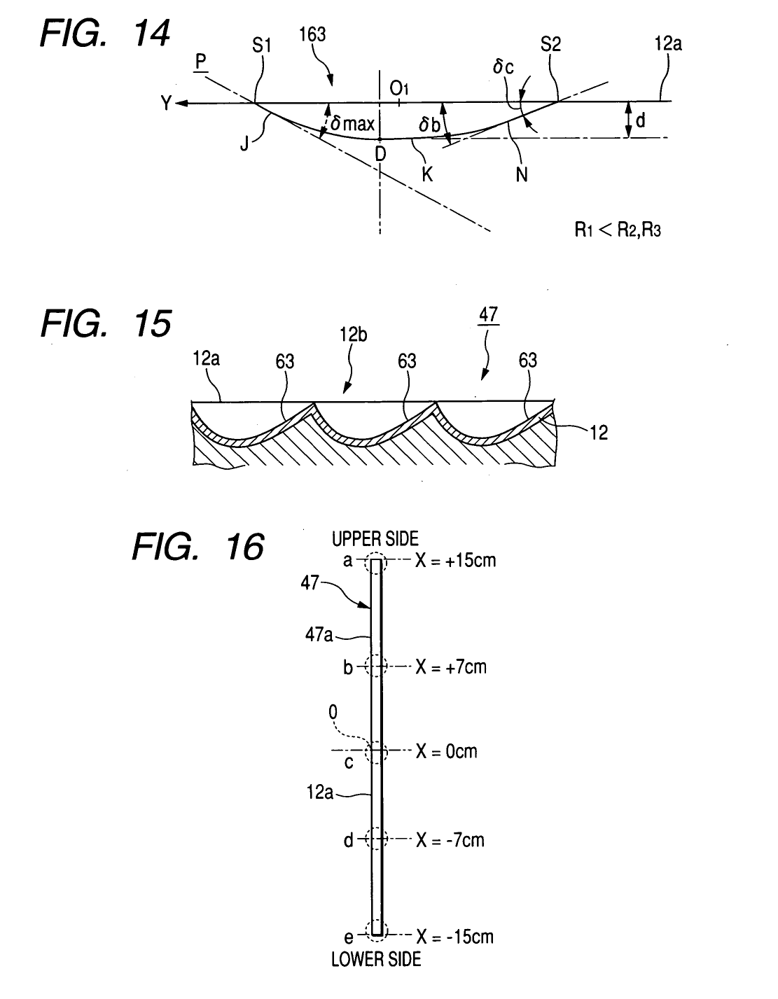

As the example of a plurality of the concave portions 63 formed on the metal reflecting film 12, at least one kind of the concave portions 70 of a first example shown in FIGS. 8 to 9, the concave portions 80 of a second example shown in FIGS. 10 to 12, the concave portions 90 of a third example shown in FIG. 13, and the concave portions 163 of a fourth example shown in FIG. 14 are adequately selected and formed in accordance with the distance from the center of the display region 47a.

Furthermore, at least one of the depth, the width (or the diameter), the curvature radius of a curved surface to be hereinafter described, and the slope angle of the curved surface of the plurality of the concave portions 63 formed on the metal reflecting film 12 can be varied in accordance with the distance from the central portion of the display region 47.

FIG. 8 illustrates an example of the reflector in the portion corresponding to the substantially central portion of the display surface and is a perspective view illustrating the concave portion 70 of the first example. FIG. 9 is a cross-sectional view in a Y-axis direction of the concave portion 70 shown in FIG. 8. The Y-axis direction is the vertical direction of the reflector in the erected state in FIG. 2 or FIG. 4. The inner side of the concave portion 70 has a curved surface which is a portion of an aspheric surface in this embodiment so that the reflection intensity distribution of the diffuse refraction light incident to the metal reflecting film having a plurality of the concave portions 70 by a predetermined angle (for example, 30°) is asymmetric on the basis of the regular reflection angle.

Concretely, the concave portion 70 is composed of a first curved surface having a small curvature and a second curved surface having a large curvature. And the first curved surface and the second curved surface have a first curve A1 from one peripheral portion S1 to a deepest point D of the concave portion 70 and a second curve B1 from the deepest point D to the other peripheral portion S2 of the concave portion 70 in smooth connection with the first curve A1, in the Y-axis direction section shown in FIG. 9, respectively.

This deepest point D is deviated from the center O1 of the concave portion 70 to the y-direction, the averages of the absolute values of the slope angles of the first curve A1 and the second curve B1 for a horizontal plane of the substrate 10 are set to be irregularly distributed in the ranges of 1° to 89° and 0.5° to 88°, respectively. And the average of the slope angle of the first curve A1 is larger than that of the second curve B1. Also, the slope angle δ a at the peripheral portion S1 of the first curve A1 representing the maximum slope angle is irregularly distributed in the range of approximately 4° to 35° in the concave portion 70.

Accordingly, the depth of each concave portion 70 is irregularly distributed in the range of 0.25 μm to 3 μm. If the depth d of the concave portion 70 is less than 0.25 μm, it is difficult to sufficiently obtain the diffuse effect of the reflected light. In addition, if the depth is more than 3 μm, the top thereof is not entirely buried by the planarization film in case of planarizing the concave portion in a following-process, and thus it is difficult to obtain the desired flatness. Also, if the depth d is more than 3 μm, since the thickness of the planarization film exceeds than 3 μm, the planarization film adjacent to the peripheral portion or the terminal portion of the panel is apt to be contracted or cracked under the condition of a high temperature and a high humidity, which is not desirable.

In addition, the diameter 1 of the concave portions 70 (the maximum diameter of the opening of the concave portion 70 in the section of the Y-axis direction shown in FIG. 9) is irregularly distributed in the range of 5 μm to 100 μm. If the diameter 1 of the concave portion 70 is less than 5 μm, since it is limited to manufacture the prototype used to form the reflector, long machining time is required. And, if the diameter 1 is more than 100 μm, it is difficult to form the shape for obtaining the desired reflection characteristic and interference light is apt to be generated. Also, the diameter 1 of the concave portion 70 may be called as an indentation diameter.

Furthermore, the concave portions 70 are arranged so that the pitches therebetween become random, and it is possible to prevent moiré attributed to the interference between the array of the concave portion 70 and the different regular patterns in the liquid crystal display panel.

Here, the term “depth of the concave portion” means the distance from the surface (the horizontal plane of the metal reflecting film 12) 12a not having the concave portion 90 in the metal reflecting film 12 to the bottom of the concave portion. The term “pitch between the adjacent concave portions” means the distance between the centers of the concave portions in the plan view.

The shape is a dimple shape which is located at x=0 cm and locating at x<0 or x>0 is varied from the dimple shape when x=0 cm.

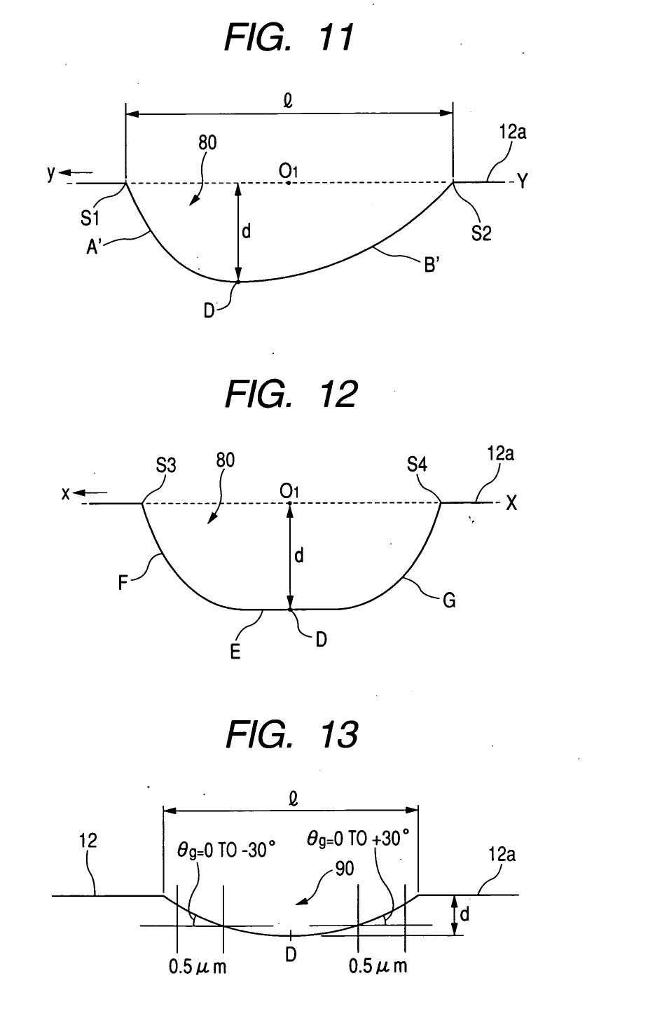

FIG. 10 is a perspective view illustrating one of the concave portions 80 of a second example and FIGS. 11 and 12 are cross-sectional views of the Y-axis direction and the X-axis direction of the concave portion 80, respectively.

The second example of the concave portion 80 has the inner shape modified from that of the first example of the concave portion 70, and allows the reflected light to have directivity in common with the concave portion 70.

Concretely, the concave portion 80 of the second example is composed of a first curved surface having a small curvature and a second curved surface having a large curvature in common with the concave portion 70, and the first curved surface and the second curved surface have a first curve A′ from one peripheral portion S1 to a deepest point D of the concave portion 80 and a second curve B′ from the deepest point D of the concave portion 80 to the other peripheral portion S2 in smooth connection with the first curve A′, in the Y-axis direction section shown in FIG. 11, respectively. The deepest point D is deviated from the center O1 of the concave portion 80 to the y-direction, the averages of the absolute values of the slope angles of the first curve A′ and the second curve B′ for the metal reflecting film surface (horizontal plane) 12a are set to be irregularly distributed in the ranges of 2° to 90° and 1° to 89°, respectively. And the average of the slope angle of the first curve A′ is larger than that of the second curve B′. Also, the slope angle δ a at the peripheral portion S1 of the first curve A′ representing the maximum slope angle is irregularly distributed in the range of 4° to 35° in each concave portion 80. Therefore, the depth of each concave portion 80 is irregularly distributed in the range of 0.25 to 3 μm.

In addition, the diameter 1 of the concave portions 80 (the maximum diameter of the opening of the concave portion 80 in the Y-axis directional section shown in FIG. 11) is irregularly distributed in the range of 5 μm to 100 μm.

Furthermore, the concave portions 80 are arranged so that the pitch between the adjacent concave portions 80 is to be random.

The shape is a dimple shape which is located at x=0 cm and locating at x<0 or x>0 is varied from the dimple shape when x=0 cm.

On the other hand, both the first curved surface and the second curved surface have a bilateral symmetric shape for the center O1 in the X-axis directional section shown in FIG. 12. The shape of the X-axis directional section has the curve E having a large curvature (that is, close to a straight line) in the periphery of the deepest point D, and the absolute value of the slope angle for the surface 12a of the metal reflecting film (the horizontal plane) is less than or equal to approximately 10°. Also, the absolute values of slope angles of the surface 12a of the deep curves F, G (the horizontal plane of the metal reflecting film) are irregularly distributed in the range of, for example, 2° to 9°.

FIG. 13 is a cross-sectional view illustrating one of the concave portions 90 according to a third example.

The concave portion 90 of the third example has the inner shape modified from that of the concave portion 70 of the first example. The inner side of the concave portion 90 of the third example has a curved surface which is a portion of the spherical surface, so that the reflection intensity distribution of the concave portion 90 is the diffuse refraction light incident to the metal reflecting film having a plurality of the concave portions 90 by a predetermined angle (for example, 30°) is substantially symmetrical in the wide range with a central focus on the regular reflection angle. Concretely, the slope angle θ g of the inner side in the concave portion 90 is set, for example, in the range of −30° to 30°.

In addition, the concave portions 90 are arranged so that the pitches therebetween is to be random and it is possible to prevent the moiré attributed to the array of the concave portions 90.

Also, the diameter 1 of the concave portion 90 (maximum diameter of the opening of the concave portion 90 shown in FIG. 13) is irregularly distributed in the range of 5 μm to 100 μm.

In addition, the depth of the concave portion 90 is irregularly distributed in the range of 0.1 μm to 3 μm. If the depth of the concave portion 90 is less than 0.1 μm, it is difficult to sufficiently obtain the diffuse effect of the reflected light. And, if the depth is more than 3 μm, the pitches between the concave portions 90 must be increased in order to satisfy the condition of the slope angle of the inner side, because the moiré may be generated.

Here, the term “depth of the concave portion 90” means the distance from the surface (the horizontal plane of the metal reflecting film) 12a not having the concave portion 90 in the metal reflecting film 12 to the bottom of the concave portion 90.

The term “pitch between the adjacent concave portions 90” means the distance between the centers of the concave portions 90 having a circle shape in the plan view. The “slope angle of the inner side of the concave portion 90” means the angle θ g for the horizontal plane of the slope surface (the horizontal plane 12a of the metal reflecting film 12) in the minute range, when taking the minute range having a width of 0.5 μm in any locations of the inner side of the concave portion 90, as shown in FIG. 13. With respect to the normal line on the surface not having the concave portion 90 in the metal reflecting film 12, for example, in FIG. 13, right-slope angle is defined as a positive angle and left-slope angle is defined as a negative angle.

The shape is a dimple shape which is located at x=0 cm and locating at x<0 or x>0 is varied from the dimple shape when x=0 cm.

FIG. 14 is a cross-sectional view illustrating one of a fourth example of concave portion 163 of a fourth example.

The fourth example of the concave portion 163 has the inner shape modified from that of the first example of the concave portion.

The inner shape of a specific longitudinal section Y in the concave portion 163 is composed of a first curve J from one peripheral portion S1 to the deepest point D of the concave portion, a second curve K from the deepest point D of the concave portion to a third curve or a straight line N in connection with the first curve J, and the third curve or the straight line N reaching the other peripheral portion S2 in connection with the second curve K. The first and second curves are connected to each other so that the slope angle for the surface (the horizontal plane) 12a is to be zero at the deepest point D.

In the concave portion 163, the slope angle of the first curve J for the surface (the horizontal plane) is steeper than the slope angle of the second curve K, the third curve or the straight line N, and the deepest point D is deviated in the Y-direction from the center O1 of the concave portion 163. In other words, the average of the absolute value of the slope angle of the first curve J for the base material surface 12a (hereinafter, referred to as the average of the slope angle of the first curve J) is larger than the average of the absolute value of the slope angle of the second curve K for the base material surface (the horizontal plane) 12a, or the average of the absolute value of the slope angle of the third curve or the straight line N for the base material surface (the horizontal plane) 12a. Also, the average of the absolute value of the slope angle of the second curve K for the base material surface (the horizontal plane) 12a (hereinafter, referred to as the average of the slope angle of the second curve K) is different from the average of the absolute value of the slope angle of the third curve or the straight line N for the base material surface (the horizontal plane) 12a (hereinafter, referred to as the average of the slope angle of the third curve or the straight line N). In the present embodiment, the average of the slope angle of the third curve or the straight line N is larger than the average of the slope angle of the second curve K.

In other words, the curvature radius R1 of the first curve J is smaller than the curvature radius R2 of the second curve K, the curvature radius R3 of the third curve or the straight line L. And the curvature radius R3 of the third curve or the straight line L is smaller than the curvature radius R2 of the second curve K. Also, in case that the curvature radius R3 is ∞, the third curve or the straight line L becomes the straight line.

The average of the slope angle of the first curve J for the surface (the horizon plane) 12a in a plurality of the concave portions 163 is irregularly distributed in the range of 1 to 89°. Also, the average of the slope angle of the second curve K for the surface (the horizon plane) 12a in a plurality of the concave portions 163a is irregularly distributed in the range of 0.5 to 88°. In addition, the average of the slope angle of the third curve or the straight line N for the surface (the horizon surface) 12a in a plurality of the concave portions 163 is irregularly distributed in the range of 0.5° to 88°.

Since the slope angles of the first curve, the second curve and the third curve or the straight line are gently changed, the maximum slope angle δ max (the absolute value) of the first curve J is larger than the maximum slope angle (the absolute value) δb of the second curve K and the maximum slope angle (the absolute value) δc of the third curve or the straight line N. Also, the slope angle of the deepest point D contacting the first curve J and the second curve K each other for the base material surface becomes zero and the first curve J having a negative slope angle and the second curve K having a positive slope angle are gently connected to each other. In addition, the second curve K and the third curve or the straight line having a positive slope angle is gently connected to each other.

In the reflector according to the present embodiment, each maximum slope angle δ max of the concave portion 163 is irregularly distributed in the range of 2 to 90°. However, many concave portions have maximum slope angle δ max irregularly distributed in the range of 4° to 35°.

Furthermore, the concave portion 163 has a single minimum point (the point has a slope angle of zero on the curved surface) D. In this case, the depth d of the concave portion 163 is defined as the distance between the minimum point D and the base material surface (the horizontal plane) 12a, and the depths d of the plurality of the concave portions are irregularly distributed in the range of 0.1 μm to 3 μm, respectively. Also, the pitches between the adjacent concave portions are irregularly distributed in the range of 5 μm to 50 μm.

In the present embodiment, specific longitudinal sections Y of the plurality of the concave portions 163 are oriented in the same direction. Also, each first curve J is formed in the Y-direction far from the observing point Ob1 of the observer. In addition, each second curve, each third curve or the straight line N is formed in the opposite direction to the Y-direction far from the observing point Ob1 of the observer.

Since the first curve J is oriented in a single direction in the portion provided with a plurality of the concave portions 163 and the average of the slope angle of the first curve J is larger than the average of the slope angle of the second curve K for the base material surface (the horizontal plane) 12a or the average of the slope angle of the third curve or the straight line L for the base material surface (the horizontal plane) 12a, the reflection characteristic is deviated from the regular reflection direction for the base material surface 12a. In other words, the bright display range of the reflected light for the incident light from the slope upper side of the Y-direction is more shifted in the normal direction for the surface from the regular reflection direction.

In addition, since the second curve K, the third curve or the straight line N is oriented in the opposite direction to the first curve J in the portion provided with a plurality of the concave portions 163 and the average of the slope angle of the third curve or the straight line N is larger than the average of the slope angle of the second curve K, as the overall reflection characteristic of a specific longitudinal section Y, the reflectivity of the direction reflected by the surface around the second curve K is increased and thus the reflectivity of the direction reflected by the surface around the third surface or the straight line L is larger than the reflectivity of the direction reflected by the surface around the second curve K. Accordingly, it is possible to obtain the reflection characteristic that the reflected light is adequately concentrated in a specific direction.

In addition, although the reflector inner-attaching type having the reflector provided between the substrate 10 and the substrate 20 to reflect the incident light from the outside is disclosed as the reflective liquid crystal display device according to the present embodiment, the reflector outer-attaching type having the reflector provided on the outside of the substrate 10 may be used.

In addition, although it is described that one retardation film is provided between the second substrate 20 and the polarization plate 28 in the embodiment, a plurality of the retardation films may be provided.

Further, although the liquid crystal display device according to an aspect of the present invention is applied to the reflective liquid crystal display device in the embodiment, it can be applied to the transflective liquid crystal display device. In this case, the minute opening is provided on the metal reflecting film of the reflector 47 or the metal reflecting film may be composed of a transflective thin film. And a back light unit may be provided on the outer side of the first substrate 10.

Also, although the reflector is composed of the organic film and the metal reflecting film (metal film) in the embodiment, the base material may be composed of the metal film having the light reflectivity such as an aluminum plate, and may perforate the surface of the base material by the tip of a punch to form a plurality of the concave portions.

In addition, although at least one kind of the concave portions of the first to the fourth examples are employed as a plurality of the concave portions formed on the metal reflecting film of the reflector in the embodiment, if at least one kind of the concave portions of the first to the fourth examples is formed so that the concave portion side is directed to the side of the substrate 10 (the lower side), (In other words, the convex side (the opposite side to the concave side) is directed to side of the substrate 20 (the upper side)), they can be employed as the convex portion formed on the metal reflecting film of the reflector related to the present invention.

Also, although the present invention is applied to the simple matrix type reflective liquid crystal display device in the embodiments, the present invention can be identically applied to an active matrix type liquid crystal display device using a thin film transistor or a thin film diode, or a segment type liquid crystal display device. These entire liquid crystal display device are in the scope of the present invention.

### EXAMPLE

By controlling the dimension of the concave portion formed on the metal reflecting film in accordance with the distance from the central portion of the display region of the reflection surface as shown in Table 1, it is provided with the reflector having uniform intensity of the reflected light in the ± expected angle, which is incident to the reflector and then is reflected from the reflection surface. Also, FIG. 16 is a side view of the reflector 47 in the erected state.

In the display region 47a of the reflector 47, H is 30 cm, L is 40 cm and θ is about 20 degree.

In addition, by using the center O of the display region 47a in the reflector 47 as the reference location (x=0), any locations x of the reflection surface 47a are represented by the distance from the center O of the display region 47a and the upper side above the horizontal line passing through the center O of the display region 47a is defined as (+) and the lower side below the horizontal line is defined as (−).

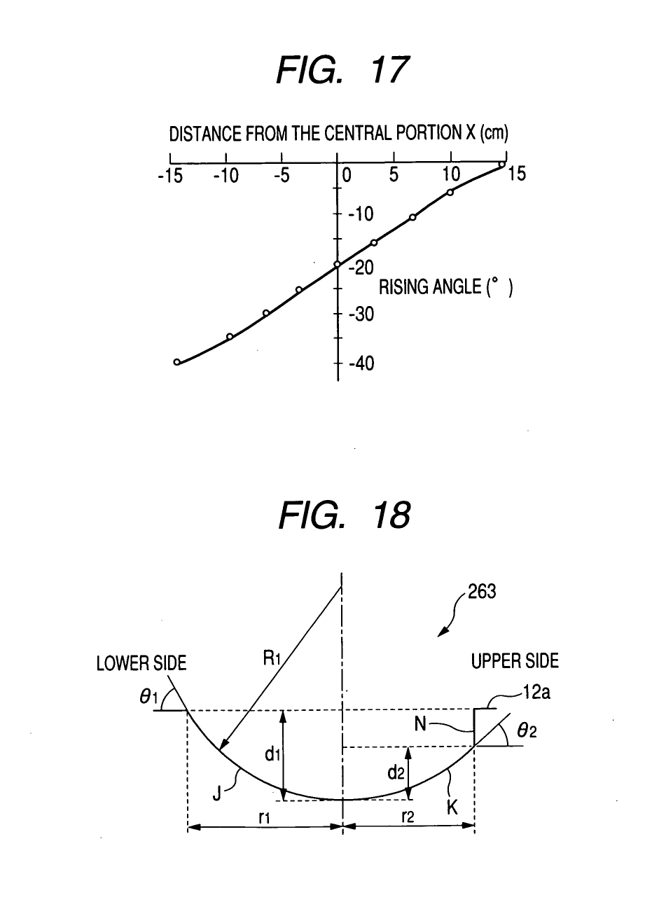

When the locations X and the expected angles corresponding to the reference numerals (a) to (e) points in FIG. 16 are the same as the followings, in the reflection characteristic of each location x (each region), the rising angle is more shifted than the rising angle when x=0 by the expected angle corresponding to each location x (each region) on the basis of the reflection characteristic when x=0 cm ((c) point) (However, the distribution width of the reflection characteristic are not varied). In FIG. 17, the relationship between the distances x (cm) from the reference location in the display region of the reflector and the rising angle (°) in the incident angle of 30 degree of the embodiment is shown.

| | | |
|---|---|---|
| (a) point | x = +15 cm, | rising angle θ = +0 degree |
| (b) point | x = +7 cm, | rising angle θ = −10 degree |
| (c) point | x = 0 cm, | rising angle θ = −20 degree |
| (d) point | x = −7 cm, | rising angle θ = −30 degree |
| (e) point | x = −15 cm, | rising angle θ = −40 degree |

FIG. 18 is a cross-sectional view illustrating the concave portion 263 (substantially equal to the concave portion 163 shown in FIG. 14) formed at the vicinity of the (c) point of the display region 47a of the provided reflector 47. Since the curvature radius R1 of the concave portion 263 formed at the vicinity of the (c) point is 15 μm and the slope angle of the third straight line N is 90°, the vertical flat surface is formed in the concave portion.

Each concave portion formed at the vicinity of (a), (b), (d), (e) point in the display region 47a is the concave portion having the value changed to the slope angle θ 1, the width r1, and the depth d1 from the horizontal plane 12a of the first curve J, and the slope angle θ 2, the width r2 and the depth d2 from the third curve or the straight line N of the second curve K of a specific vertical section of the concave portion 263 formed at the vicinity of (c) point to the values of

TABLE 1

| Location | θ ₁(° ) | d1 (μm) | r1 (μm) | θ ₂(° ) | d2 (μm) | r2 (μm) |
|---|---|---|---|---|---|---|
| (a) | 15 | 0.5 | 3.9 | 20 | 0.9 | 5.1 |
| (b) | 20 | 0.9 | 5.1 | 15 | 0.5 | 3.9 |
| (c) | 25 | 1.4 | 6.3 | 10 | 0.23 | 2.6 |
| (d) | 30 | 2 | 7.5 | 5 | 0.05 | 1.3 |
| (e) | 35 | 2.7 | 8.6 | 0 | 0 | 0 |

Furthermore, for comparison, except that a plurality of the concave portions formed in the display region have the same conditions as conditions of the concave portions 263 formed at the (c) point, the reflector having the same dimensions as that of the embodiment is provided and is used as a comparative example.

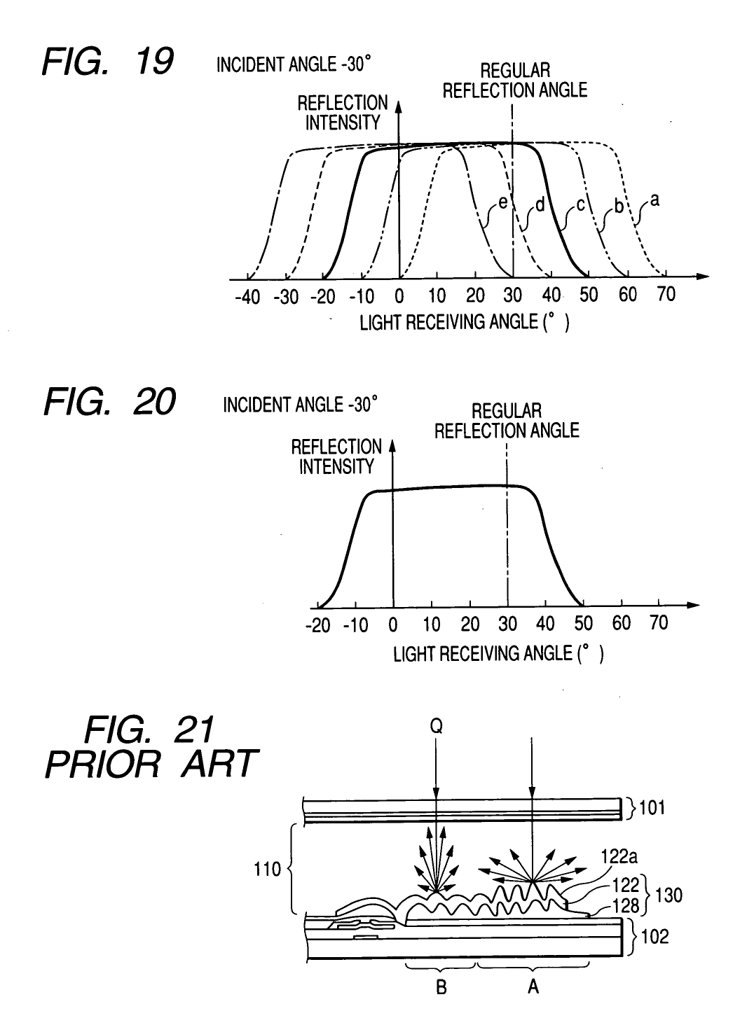

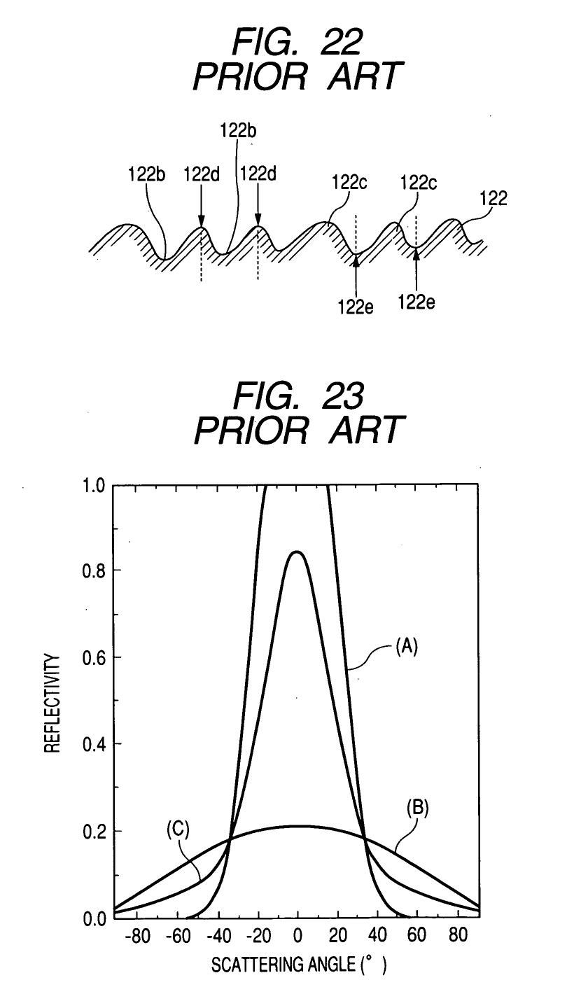

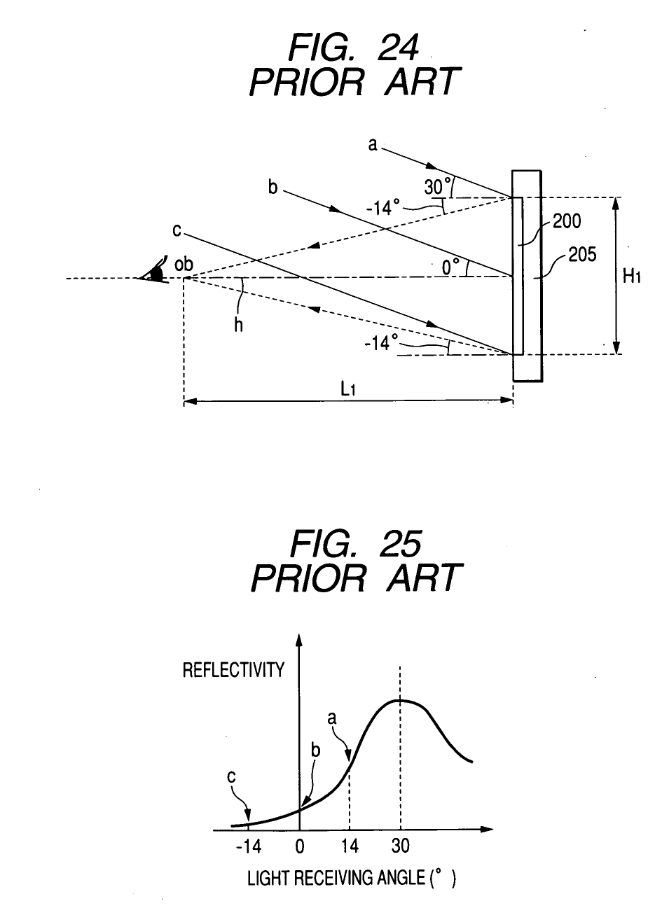

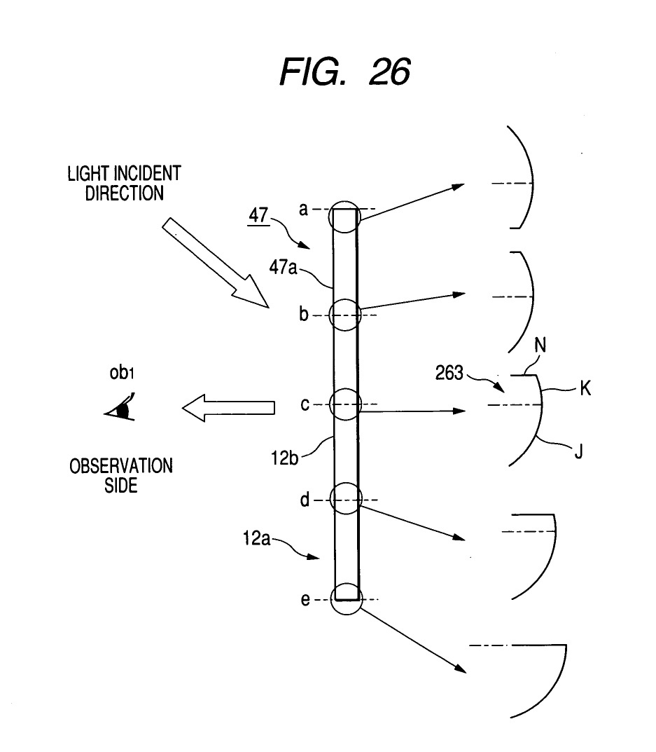

FIGS. 19 to 20 shows the reflection characteristics when the light is incident to the reflectors of the embodiment and the comparative example by the incident angle of −30 degree. FIG. 26 schematically shows each concave portion formed at the vicinity of the (a), (b), (c), (d), and (e) points of the reflector according to the embodiment. The depth of each concave portion formed at the vicinity of the (a), (b), (c), (d), and (e) points of the display region 47a in the reflecting plate according to the embodiment is varied so that the depth of the concave portions formed in upper side is gradually shallower than the depth of the concave portions formed in lower side. Also, in the embodiment, each concave portion formed at the vicinity of the (b) to (e) points is formed so that the side of the plane becomes the upper side. And the concave portion formed at the vicinity of the (a) point is formed so that the side of the plane becomes the lower side. From the results shown in FIGS. 19 to 20, it is noted that the reflector of the embodiment has a large reflection intensity in the wide light receiving angle range and a small deviation of the reflection intensity in comparison with the comparative example. Therefore, according to the reflector of the embodiment, sufficiently large uniform luminance can be obtained even in a large area.

As above-mentioned, according to the reflector of an aspect of the present invention, the uniform and sufficiently high luminance can be obtained, although the area of the display surface is increased.

Moreover, according to the liquid crystal display device of an aspect of the present invention, since the reflector of an aspect of the present invention is provided inside or outside the liquid crystal cell, the uniform brightness can be obtained and the visibility can be improved, although the area of the display region is increased.

1. A reflector having a reflection surface provided in a liquid crystal display device,
wherein a reflection characteristic of the reflector is varied in accordance with a distance from a central portion of a display region in the reflection surface, an intensity of the light which is incident to the reflector and reflected on the reflection surface is uniform in the range of ± an expected angle, and the expected angle satisfies the relationship expressed by following formula (1)
θ(degree)=tan⁻¹(H/2 L) (1)
θ is the expected angle, H is the dimension of a vertical direction of the display region and is in the range of 2 cm to 30 cm, and L is a distance from a center of the display region to an observing point and is in the range of 10 cm to 300 cm).

2. The reflector according to claim 1,
wherein the reflection characteristic has a rising angle at an upper portion located above the central portion in the display region is shifted to a high angle side in comparison with one at the central portion, and a rising angle at a lower portion located below the central portion in the display region is shifted to a low angle side in comparison with one at the central portion.

3. The reflector according to claim 1,
wherein the center of the display region is a reference location and any locations x in the reflection surface is represented by the distance from the center of the display region, in case that an upper side above the center of the display region is defined as (+) and a lower side below the center of the display region is defined as (−), the reflection characteristic at any location x in the reflection surface a is shifted by θ (degree)=tan⁻¹(x/L) from reflection characteristic at the reference location (In the formula, L is the distance from the center of the display region to the observing point and θ is the expected angle).

4. The reflector according to claim 1,
wherein, the reflector has a plurality of reflective concave portions irregularly formed on a metal film formed on a base material or a surface of the base material, an inner side of the concave portion has a curved surface which is a portion of a spherical surface or an aspheric surface, and a slope of a sectional curve of a longitudinal section between adjacent concave portions or boundaries of the concave portions is discontinuous so that the metal film or the surface of the base material is to be the reflection surface,
wherein at least one of a depth, a width, a curvature radius of a curved surface, and a slope angle of the curved surface of the plurality of the concave portions is varied in accordance with the distance from the central portion of the display region in the reflection surface.

5. The reflector according to claim 1,
wherein the reflector has a plurality of reflective convex portions irregularly formed on a metal film formed on a base material or a surface of the base material, an inner side of the convex portion has a curved surface which is a portion of a spherical surface or an aspheric surface, and a slope of the sectional curve of a longitudinal section between adjacent convex portions or boundaries of the convex portions is discontinuous so that the metal film or the surface of the base material is to be the reflection surface,
wherein at least one of a depth, a width, a curvature radius of a curved surface and a slope angle of the curved surface of the plurality of the convex portions is varied in accordance with the distance from the central portion of the display region in the reflection surface.

6. A liquid crystal display device, wherein an electrode and an orientation film are formed at an inner side of one substrate which is an observing side among a pair of substrates which face each other through a liquid crystal layer and the liquid crystal formed with an electrode and an orientation film are provided at the inner side of the other substrate far from the observing side,
wherein the reflector according to claims 1 is formed between the other substrate and the orientation film formed at the inner side thereof or on the outer side of the other substrate.

7. The reflector according to claim 2,
wherein, the reflector has a plurality of reflective concave portions irregularly formed on a metal film formed on a base material or a surface of the base material, an inner side of the concave portion has a curved surface which is a portion of a spherical surface or an aspheric surface, and a slope of a sectional curve of a longitudinal section between adjacent concave portions or boundaries of the concave portions is discontinuous so that the metal film or the surface of the base material is to be the reflection surface,
wherein at least one of a depth, a width, a curvature radius of a curved surface, and a slope angle of the curved surface of the plurality of the concave portions is varied in accordance with the distance from the central portion of the display region in the reflection surface.

8. The reflector according to claim 3,
wherein, the reflector has a plurality of reflective concave portions irregularly formed on a metal film formed on a base material or a surface of the base material, an inner side of the concave portion has a curved surface which is a portion of a spherical surface or an aspheric surface, and a slope of a sectional curve of a longitudinal section between adjacent concave portions or boundaries of the concave portions is discontinuous so that the metal film or the surface of the base material is to be the reflection surface,
wherein at least one of a depth, a width, a curvature radius of a curved surface, and a slope angle of the curved surface of the plurality of the concave portions is varied in accordance with the distance from the central portion of the display region in the reflection surface.

9. The reflector according to claim 2,
wherein the reflector has a plurality of reflective convex portions irregularly formed on a metal film formed on a base material or a surface of the base material, an inner side of the convex portion has a curved surface which is a portion of a spherical surface or an aspheric surface, and a slope of the sectional curve of a longitudinal section between adjacent convex portions or boundaries of the convex portions is discontinuous so that the metal film or the surface of the base material is to be the reflection surface,
wherein at least one of a depth, a width, a curvature radius of a curved surface and a slope angle of the curved surface of the plurality of the convex portions is varied in accordance with the distance from the central portion of the display region in the reflection surface.

10. The reflector according to claim 3,
wherein the reflector has a plurality of reflective convex portions irregularly formed on a metal film formed on a base material or a surface of the base material, an inner side of the convex portion has a curved surface which is a portion of a spherical surface or an aspheric surface, and a slope of the sectional curve of a longitudinal section between adjacent convex portions or boundaries of the convex portions is discontinuous so that the metal film or the surface of the base material is to be the reflection surface,
wherein at least one of a depth, a width, a curvature radius of a curved surface and a slope angle of the curved surface of the plurality of the convex portions is varied in accordance with the distance from the central portion of the display region in the reflection surface.

11. A liquid crystal display device, wherein an electrode and an orientation film are formed at an inner side of one substrate which is an observing side among a pair of substrates which face each other through a liquid crystal layer and the liquid crystal formed with an electrode and an orientation film are provided at the inner side of the other substrate far from the observing side,
wherein the reflector according to claim 2 is formed between the other substrate and the orientation film formed at the inner side thereof or on the outer side of the other substrate.

12. A liquid crystal display device, wherein an electrode and an orientation film are formed at an inner side of one substrate which is an observing side among a pair of substrates which face each other through a liquid crystal layer and the liquid crystal formed with an electrode and an orientation film are provided at the inner side of the other substrate far from the observing side,
wherein the reflector according to claim 3 is formed between the other substrate and the orientation film formed at the inner side thereof or on the outer side of the other substrate.
